(19) United States
(12) Patent Application Publication
(10) Pub. No.: US 2016/0053199 A1
(43) Pub. Date: Feb. 25, 2016

(54) METHOD AND APPARATUS FOR THE EXTRACTION OF OIL FROM OLIVES OR OTHER OIL-FRUITS

(71) Applicant: UNIVERSITA DEGLI STUDI DI BARI "ALDO MORO", Bari (IT)

(72) Inventor: Maria Lisa CLODOVEO, Bari (IT)

(21) Appl. No.: 14/778,224

(22) PCT Filed: Mar. 18, 2013
(86) PCT No.: PCT/IT2013/000079

§ 371 Date: Sep. 18, 2015

(51) Int. Cl. C11B 1/10; A23L 1/00; A23N 1/02; C11B 1/06; C11B 1/04

(52) U.S. Cl. CPC C11B 1/10; C11B 1/06; C11B 1/04; A23N 1/02; A23L 1/0002; A23V 2002/00

(57) ABSTRACT

The present invention relates to a method and to an apparatus for extracting virgin olive oil from olives and other oil-fruits allowing to reduce the production time by guarantee the product qualitative level.

The present invention relates to a method and apparatus for extracting virgin olive oil from olives and other oil-fruits.

As it is well known, currently the systems for extracting mechanically the virgin olive oils from olives are basically of two types: systems of discontinuous type and systems of continuous type.

The systems of discontinuous type, generally constituted by a grinder combined with hydraulic presses, generally have a low work capacity and inevitably request a lot of manpower. For these reasons they are considered obsolete and they are disappearing, replaced by systems of continuous type.

The systems defined of continuous type generally are constituted by a mechanical crusher, a malaxator and a centrifugal separator with horizontal axis (decanter).

The designation “continuous” relates to the fact that two of the three machines composing the system operate continuously (crusher and decanter), the malaxator, which actually is a machine operating in batches, is placed between these two continuous apparatuses.

Traditionally, the malaxation phase consists in mixing slowly (12-18 revolutions per minute) the olive paste at 27-32° C. for a period of time comprised between 30 and 60 minutes depending upon the features of the raw material. The malaxation purpose is to promote the coalescence of the tiny oil drops in drops with greater sizes which can be separated more easily in a centrifugal field on one hand, to reduce the olive paste viscosity value so as to optimize the phase separation inside the decanter (oil/vegetable water/pomace) on the other hand.

The malaxation phase actually represents the “bottleneck” of the continuous extraction process. Currently the system used to guarantee continuity to the process, without interrupting the activity of the machines upstream and downstream of the malaxator, consists in placing several malaxating machines parallelly with the burden of a strong plant investment. The oil mills which are not equipped with several malaxators placed parallelly actually operate in a discontinuous way and they do not fully exploit the work capacity of crusher and decanter.

One of the critical factors determining so long malaxation time is constituted by the period necessary so that the just crushed olive paste reaches the traditional process temperature (27-32° C.). Such period on the average lasts at least one third of the total malaxation time as the olive paste outgoing from the crusher can have temperatures comprised between 18 and 26° C. depending upon the temperature of the environment wherein one operates and upon the used crusher type.

The current malaxators available on the market, from a plant point of view, are not efficient heat exchangers due to an unfavourable volume/surface ratio which translates into a limited heat exchange area for a huge mass of olive paste.

As it is known, in the traditional conventional techniques for heating the olive paste, controlled by convection and conduction mechanisms, the whole heat energy existing in the heating fluid must cross the olive paste mass: the heat flow speed is function of the heat gradient existing between the two fluids and the olive paste thermal diffusivity.

Therefore, the object of the present invention is to solve the problems still left opened by the known art and this is obtained by a method as defined in claim 1.

An additional object of the present invention is an apparatus suitable to operate in batches and/or continuously and to be installed on traditional or new lines allowing to make the whole process operating under all (normal, vacuum-sealed, modified or controlled) atmosphere conditions as defined in claim 13.

The present invention, by overcoming the problems of known art, involves several and evident advantages.

In particular, the present invention allows reducing the production time by guaranteeing the product quality level. The modularity of the industrial plants for the mechanical extraction of virgin olive oils from olives allows inserting such device even on already existing transformation lines.

The optimization of the line work capacity allows reducing the number of malaxators placed parallelly with a consequent reduction in the initial investments, furthermore it may guarantee a construction simplification of the malaxators which from jacketed heat exchangers can be converted into simple insulated stirring tanks with additional saving in the plant costs.

Furthermore it may determine an increase in the extraction yields and a reduction in the by-products with increase in the profits obtainable from the product.

The advantages of the method for microwave dielectric heating in the extraction of virgin olive oil from olives and other oil-fruits with respect to the conventional one are:
more effective and selective heating
considerable process time reduction
yield increase and reduction in by-products
faster and safe heating control
less space requirements of apparatuses
possibility of working at even higher temperatures than the conventional ones
applicability even for biological productions and reduction in the process environmental impact
process operating cost reduction

Other advantages, together with the features and the use modes of the present invention will result evident from the following detailed description of preferred embodiments thereof, shown by way of example and not for limitative purpose, by referring to the figures of the enclosed drawings, wherein:

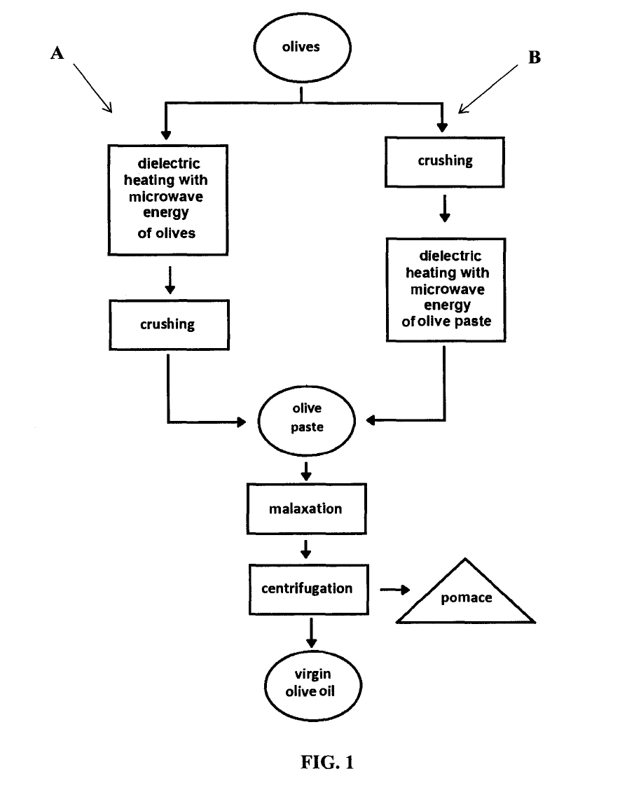

FIG. 1 is a flow diagram illustrating two possible embodiments of the process according to the present invention;

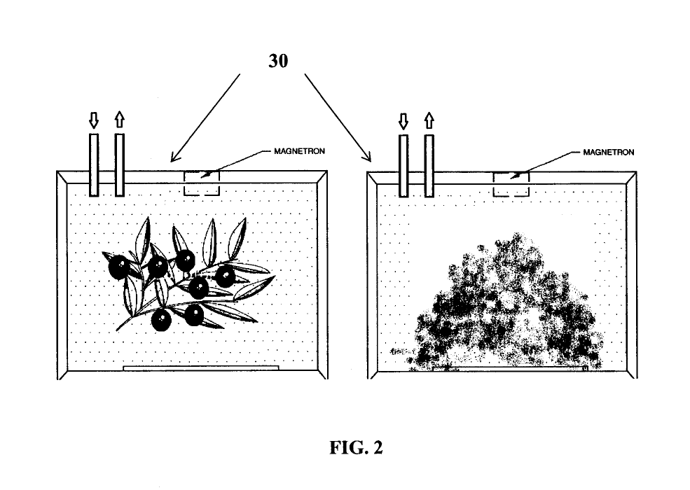

FIG. 2 is a schematic representation, shown by way of example and not for limitative purpose, of a device of dielectric heating by means of microwave operating in batches (oven) on the unbroken or crushed olives and which can be placed upstream or downstream of the crusher;

FIG. 3 is a schematic representation, shown by way of example and not for limitative purpose, of a first embodiment of an apparatus according to the present invention, wherein a device of dielectric heating by means of microwaves operating continuously (tunnel) onto the unbroken olives is placed upstream of the crusher;

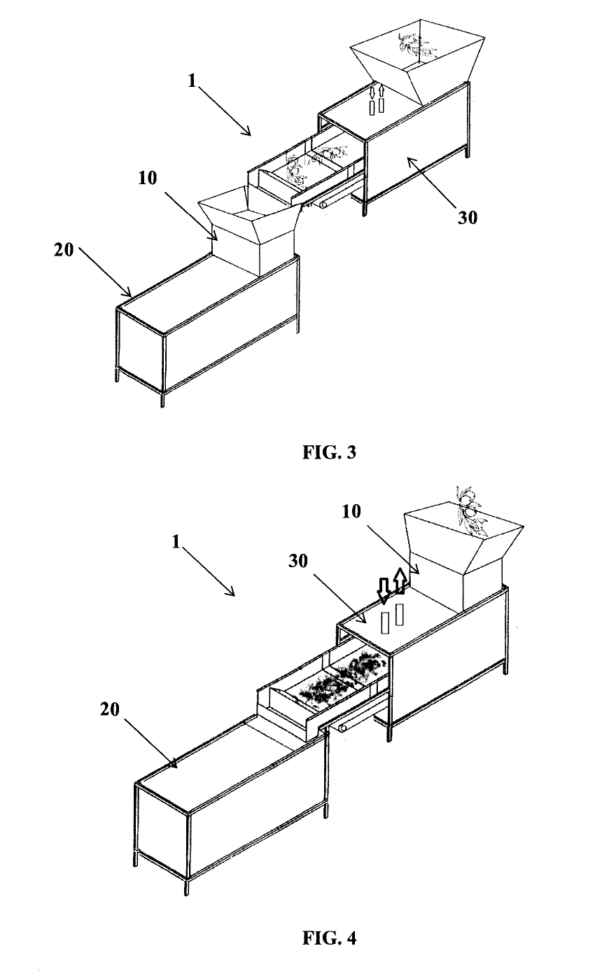

FIG. 4 is a schematic representation, shown by way of example and not for limitative purpose, of a second embodiment of an apparatus according to the present invention, wherein a device of dielectric heating by means of microwaves operating continuously (tunnel) onto the crushed paste is placed downstream of the crusher;

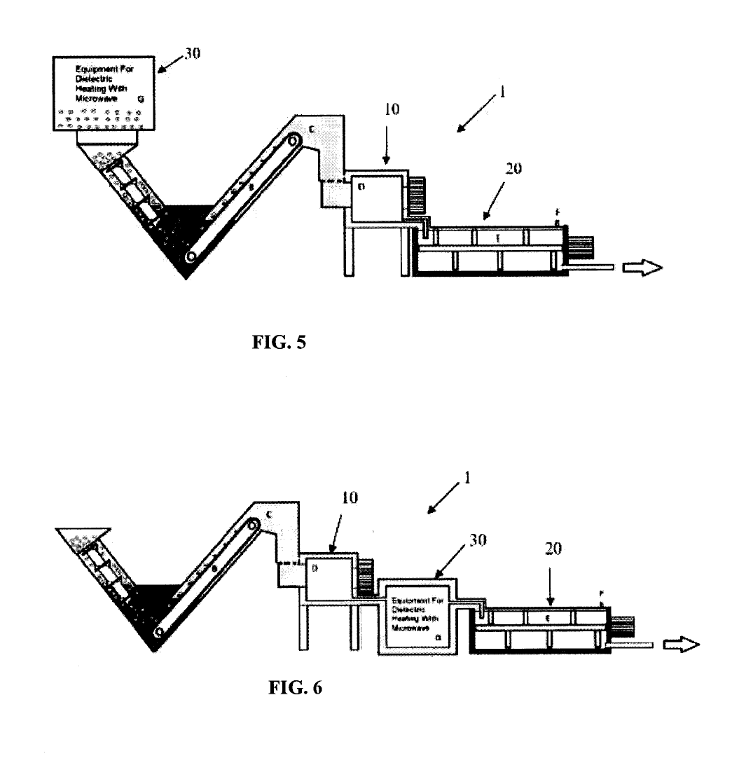

FIG. 5 is a schematic representation, shown by way of example and not for limitative purpose, of a third embodiment of an apparatus according to the present invention, allowing to make the whole process to operate under all (normal, vacuum-sealed, modified or controlled) atmosphere conditions and which provides the insertion of a dielectric heating device by means of microwaves upstream of the crusher;

FIG. 6 is a schematic representation, shown by way of example and not for limitative purpose, of a fourth embodiment of an apparatus according to the present invention, allowing to make the whole process to operate under all (normal, vacuum-sealed, modified or controlled) atmosphere conditions and which provides the insertion of a dielectric heating device by means of microwaves downstream of the crusher;

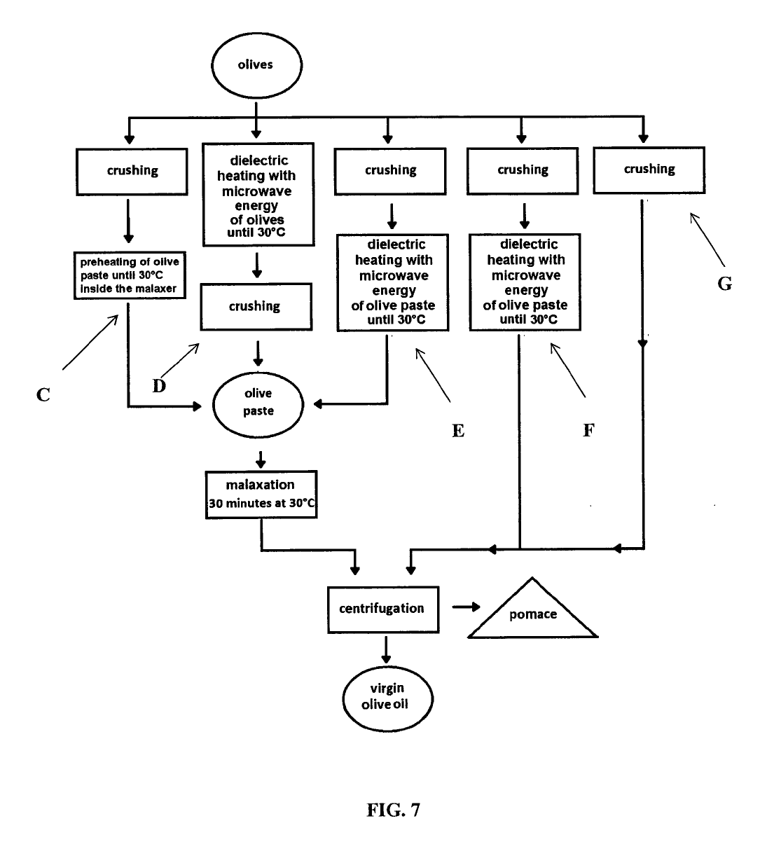

FIG. 7 is a flow diagram illustrating the implementation modes of the experimental activity;

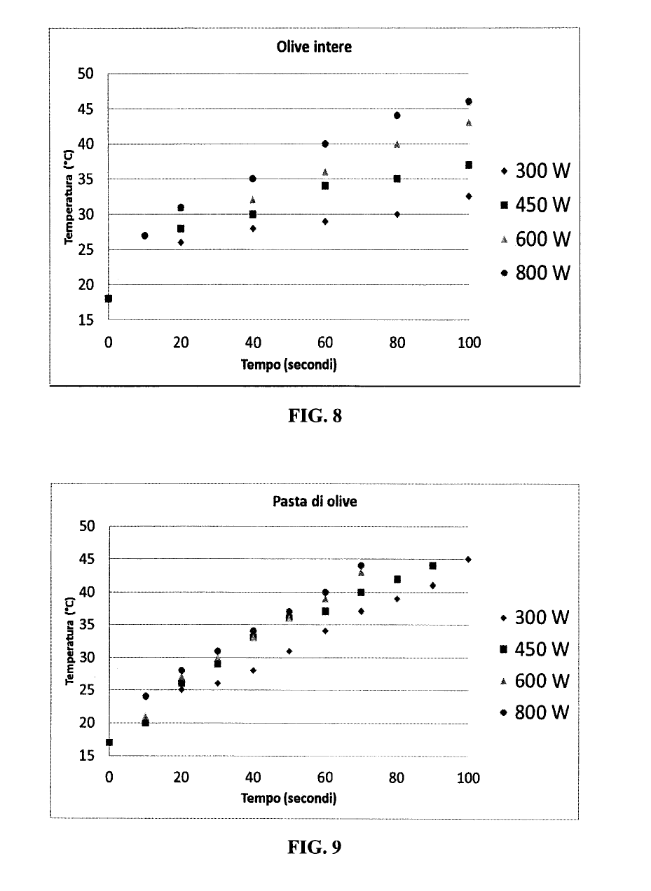

FIG. 8 is a graph showing the temperature profiles of olive paste obtained with the microwave dielectric heating of the unbroken olives;

FIG. 9 is a graph showing the temperature profiles of olive paste obtained with the microwave dielectric heating of olive paste; and

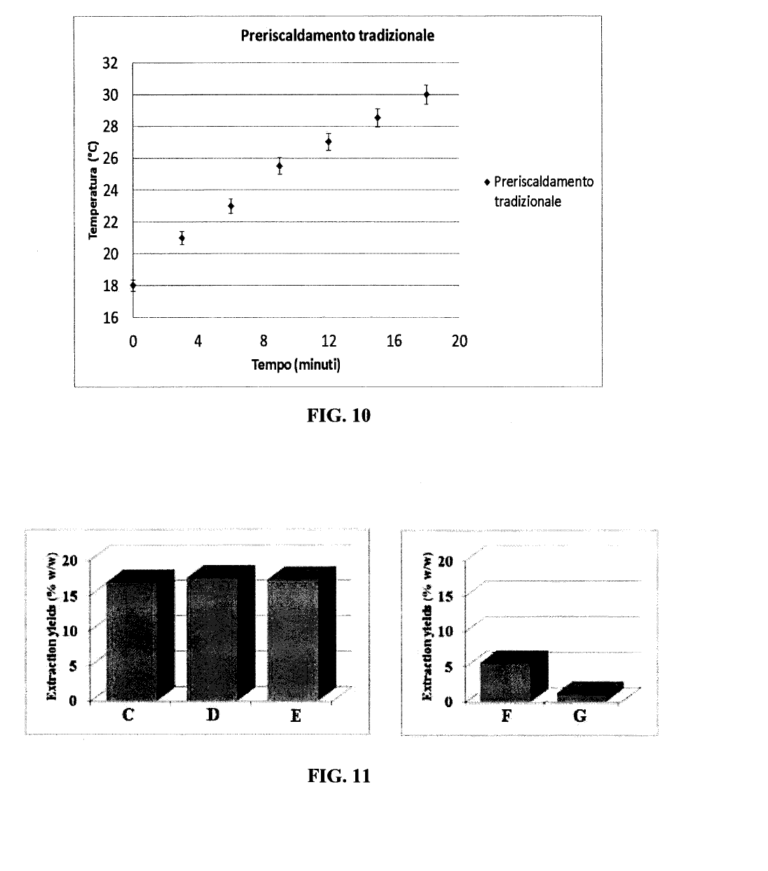

FIG. 10 is a graph showing the temperature profiles of olive paste obtained with the traditional heating by conduction/convection inside the malaxator steel tank water-bath heated at 35° C.

The present invention will be described hereinafter by referring to the above-mentioned figures.

### PRINCIPLE OF THE METHOD ACCORDING TO THE PRESENT INVENTION

Microwaves are not-ionizing electromagnetic waves with wavelength comprised between 1 mm (v=300 GHz) and 1 m (v=300 MHz), situated in the spectrum area between the frequencies of infrared and that of the radio waves.

Table 1 shows ISM frequencies, allowed for Industrial, Scientific and Medical purposes.

TABLE 1

| Frequency | Wavelenght |
|---|---|
| MHz | cm |
| 433.92 ± 0.2% | 69.14 |
| 915 ± 13 (*) | 32.75 |
| 2450 ± 50 | 12.24 |
| 5800 ± 75 | 5.17 |
| 24125 ± 125 | 1.36 |

(*) not allowed in Germany

The effects of thermal nature of microwaves show considerably exclusively for substances with dipole moment. The “heat” effect can then be explained by the energy absorption by the polar molecules in the liquids or solids interacting with the oscillating electric field determined by the radiation (dielectric heating). The higher the substance polarity, the higher its capability of absorbing heat from microwaves will be.

Even in the considered case the thermal transfer inside the mass of unbroken or crushed olives by means of microwaves is no more conditioned by the surface diffusivity and temperature, as it took place in the conventional process, consequently the heating time can be reduced even to less than 1% of the one requested by the traditional techniques. In fact, exactly thanks to the high penetration depth thereof, sufficient to involve the whole mass of the unbroken or crushed fruits, it results to be much faster than the conventional one, essentially superficial and generated by a temperature gradient with respect to the outer heat source. While the latter in fact requests minutes or hours, the dielectric one needs no more than few seconds or minutes.

Therefore, according to the present invention, a method for extracting oil from olives and oil-fruits is provided wherein the heat necessary to extract the lipid matrix is administered to the unbroken or crushed olives by using a dielectric heating device by means of microwaves which can operate in batches (oven) or continuously (tunnel) in traditional or new lines and under all (normal, vacuum-sealed, modified and controlled) atmosphere conditions.

The process according to the present invention is outlined in the flow diagram of FIG. 1 and comprises a phase of crushing the olives, in order to obtain an olive paste and a phase of malaxating the olive paste, to favour, by means of the slow malaxation and heating of the above-mentioned olive paste, the coalescence of the oil drops.

The thermal treatment of olive paste in the traditional systems takes place by means of a slow and ineffective conduction/convection mechanism, therefore the present invention proposes to accelerate the paste heating by means of treating the olives or the olive paste itself with a microwave dielectric system.

The microwave dielectric heating treatment can be performed, indifferently with the same device, onto the olives, before crushing (branch A in diagram of FIG. 1) or onto the olive paste, after crushing (branch B in diagram of FIG. 1).

In any case the reduction in the malaxation time even allows replacing the traditional malaxator with an insulated tank without the need for an outer thermal jacket for the heating fluid circulation, with an additional reduction in the plant costs.

The heating of the unbroken or crushed fruits can be performed at the traditional temperatures (27-30° C.), but it can even be used in not traditional treatments at high temperatures, therefore in a very wide range (from 20° C. to more than 200° C.).

Therefore, the thermal treatment comprises a heating at a temperature comprised between 20° C. and 250° C., preferably between 20° C. and 40 ° C., still more preferably 30° C., under all (normal, vacuum-sealed, modified and controlled) atmosphere conditions. Advantageously high temperatures can be used, up to 250° C., if the matrix is protected by means of excluding oxidizing agents such as oxygen.

Furthermore, according to the present invention, the malaxation phase can be performed at a controlled malaxation temperature, between 20° C. and 250° C., preferably at 30° C.

The use of the microwave dielectric heating method can take place by means of devices in batches (oven) and/or continuously (tunnel).

Advantageously, the method according to the present invention can provide that the crushing phase and/or the malaxation phase are performed in atmosphere, under all (normal, vacuum-sealed, modified and controlled) atmosphere conditions, preferably obtained by means of inletting a gas or a gas mixture in the crushing and/or malaxation environment or by sucking air.

By way of example such gas (or gas mixture) can be chosen among; nitrogen, argon, carbon dioxide, helium or a mixture of the same or other gases, brought to a higher pressure than the atmospheric pressure in the crushing and/or malaxation environment.

In this case, the microwave dielectric heating combined with a controlled or modified or vacuum-sealed effectiveness will allow to operate even at not conventional temperatures of 60°-70° C. and higher ones, by benefiting from the possibility of working even in whole oxygen absence, by protecting the product from unwished oxidations and at the same time by increasing the extraction yields and consequently the producers' gain.

The present invention is also directed to an apparatus 1 for extracting oil from olives or oil-fruits, operating according to what described sofar. FIGS. 2, 3, 4, 5, 6 relate to embodiments thereof shown by way of example and not for limitative purposes.

Such apparatus comprises a crusher 10 to obtain olive paste; and a malaxator 20 to malaxate said olive paste.

Furthermore, the apparatus provides a section 30 for the thermal treatment of olives or olive paste, comprising microwave dielectric heating means 30 able to operate under all (normal, vacuum-sealed, modified and controlled) atmosphere conditions.

Such microwave dielectric heating means could be provided with power and capacity features adapted to the plant sizes and to the quantities of the product to be treated and to the temperature thereat one want to operate knowing that they should be apt to perform a thermal treatment at a heating temperature comprised between 20° C. and 250° C., preferably between 20° C. and 40° , still more preferably at 30° C. The power can vary from 1500 W for small pilot plants to 30 kW for plants able to work from 3000 to 5000 kg/hour.

The modularity of the industrial plant for the mechanical extraction of the virgin olive oils from olives allows inserting the microwave heating means even on transformation lines currently already under production or already placed in the oil mills, without involving the complete renovation of the plants. To this purpose, according to the present invention the thermal treatment section can be placed upstream (as illustrated in the plant in FIGS. 3 and 5) or downstream of the crusher (as illustrated in the plant in FIGS. 4 and 6).

Furthermore, preferably, even the malaxator can comprise autonomous heating means apt to control the malaxation temperature between 20° C. and 250° C., preferably at 30° C., but it can also be replaced by a simple insulated stirring tank with addition saving in plant costs.

According to an embodiment, the crusher and/or the malaxator are apt to operate in modified or controlled or vacuum-sealed atmosphere. To this purpose, the apparatus can provide means for modifying or controlling the atmosphere of the crusher and/or the malaxator, in order to obtain a processing in modified or controlled or vacuum-sealed atmosphere. Preferably, such means for controlling or modifying the atmosphere comprise means for inletting or removing gas in the crushing and/or malaxation environment, if inlet said gas can be chosen among: nitrogen, argon, carbon dioxide, helium or other gases, said means for controlling or modifying the atmosphere being apt to bring said gas at a higher pressure than the atmospheric pressure in the crushing and/or malaxation environment.

Experimental Activity

Seed extraction tests were performed on pilot scale by using a system for heating unbroken or crushed fruits by means of microwaves.

The microwave technology was chosen as it well suits to be used in developing new processes and intensifying the existing processes.

The main advantage derives from the selective heating of the matrixes allowing both to reduce significantly the process time, with advantages both from the point of view of energy and investment costs, and from the point of view of the yield increase and by-product reduction.

The pilot tests were performed by using olives of the Coratina cultivar gathered in Bari province, transported in fenestrated trays with capacity of 30 kg filled up by ⅔ in volume and processed within 24 hours from harvesting.

The seed extraction tests were performed according to the experimental protocol shown in FIG. 7.

For the seed extraction a pilot plant was used constituted by the following apparatuses:

a. Hammer crusher

b. Steel malaxator with water heating and stirring system with vertical axes

c. Basket centrifuge

d. Microwave heating apparatus.

The microwave apparatus used in the seed extraction tests on pilot scale was characterized by the following structural features:
Produced power: from 100 W to 800 W
Operating frequency: 2450 MHz
Magnetron: OM75P (31)
Chamber inner sizes: 33 ×211×324 mm

Such apparatus can be set on different power levels: 300 W, 450 W, 600 W and 800 W.

For each power the dual concepts time/temperature in a range comprises between 20 and 50° C. were evaluated.

Procedure for Extracting Virgin Olive Oils

After having removed the leaves and other foreign objects, the olives were subjected to washing and divided into 500-g homogeneous lots.

The microwave dielectric heating was applied in the extraction process with three different modes (branches D, E, F of the flow diagram in FIG. 4):

D) On the unbroken olives before crushing by applying a dual concept of time/suitable suitable to reach almost immediately 30° C., after such process a malaxation at 30° C. for 30 minutes was performed, followed by centrifugation.

E) On the olive paste immediately after crushing by applying a dual concept of time/suitable suitable to reach almost immediately 30° C., after such process a malaxation at 30° C. for 30 minutes was performed, followed by centrifugation.

F) On the olive paste immediately after crushing by applying a dual concept of time/suitable suitable to reach almost immediately 30° C. and after such process directly the extraction by centrifugation was performed.

Parallelly the traditional process for heating/malaxating the olive paste (branch C of diagram) was performed, according thereto the olives were crushed, the olive paste temperature was measured, subsequently the same was placed inside the steel tank of the malaxator dipped in water bath at 35° C. The paste was then stirred by controlling the temperature until reaching 30° C. (preheating), thereafter a malaxation at 30° C. for 30 minutes was performed.

Parallelly the oil extraction by centrifugation process was performed without heating and malaxation (branch G of diagram),

The main qualitative parameters needed to define the commercial class of the product (EEC/2568/91 and subsequent modifications) were determined on the extracted oils.

The evaluation of the influence of using microwave dielectric heating on the extraction yields of the virgin olive oil from olives was made by centrifuging 50 g of olive paste in Falcon tubes in a laboratory centrifuge (Beckman Coulter—Allegra X-22 Series) for 40 minutes:

The oil which separated from centrifugation was weighed and expressed as percentage with respect to the paste initial weight.

Test Results

Effect of the Microwave Dielectric Heating of Unbroken Olives on the Olive Paste Temperature.

FIG. 8 shows the temperature profiles of olive paste obtained with the microwave dielectric heating of the unbroken fruits. The leaf-free and washed olives were divided into 500-g homogeneous lots.

Each lot was subjected to heating by applying the four power levels (300 W, 450 W, 600 W, 800 W) for different time ranges (20, 40, 60, 80, 100 seconds). After the thermal treatment the olives were crushed with mechanical crusher and the obtained olive paste temperature was measured.

FIG. 8 shows that 500 g of olive paste reach 30° C. after a microwave treatment of the unbroken olives for 20 seconds at 600/800 W, for 40 seconds at 450 W and for 80 seconds at 300 W.

Effect of the Microwave Dielectric Heating of Olive Paste on the Olive Paste Temperature

FIG. 9 shows the temperature profiles of olive paste obtained with the microwave dielectric heating of the crushed fruits. The leaf-free and washed olives were divided into 500-g homogeneous lots.

Each lot was crushed with mechanical crusher, subjected to heating by applying the four power levels (300 W, 450 W, 600 W, 800 W) for different time ranges (10, 20, 30, 40, 50, 60, 70, 80, 90, 100 sec) and at the treatment end the obtained olive paste temperature was measured.

FIG. 9 shows that 500 g of olive paste reach 30° C. after a treatment for 30 seconds at 600/800 W, after a time comprised between 30 and 40 seconds at 450 W, and in 50 seconds at 300 W.

FIG. 10 shows the olive paste temperature profile obtained with the traditional heating by conduction/convection inside the steel tank of the malaxator water-bath heated at 35° C. The leaf-free and washed olives were divided into 500-g homogeneous lots.

Each lot was crushed with mechanical crusher, subjected to traditional heating in malaxator.

FIG. 10 shows that the paste reaches 30° C. after 18 minutes with the traditional heating by conduction/convection inside the malaxator steel tank water-bath heated at 35° C.

It may be concluded that the introduction of the microwave dielectric heating technology in the process for extracting virgin olive oil from olives reduces the time for preheating the paste to be malaxated by an average percentage of 95%.

Effect of the Microwave Dielectric Heating of Unbroken and Crushed Fruits on the Produced Oil Quality

To the purpose of evaluating the produced oil quality by using the microwave dielectric heating in the extraction process the following process conditions were taken into consideration:

a) Traditional process: crushing, preheating until 30° C., malaxation for 30 minutes at 30° C. and extraction by centrifugation;

b) Process according to the present invention: microwave dielectric heating of olives for 80 seconds at 300 W crushing, malaxation for 30 minutes at 30° C. and extraction by centrifugation;

c) Process according to the present invention: microwave dielectric heating of olives for 20 seconds at 800 W, crushing, malaxation for 30 minutes at 30° C. and extraction by centrifugation;

d) Process according to the present invention: crushing, microwave dielectric heating of paste for 50 seconds at 300 W, malaxation for 30 minutes at 30° and extraction by centrifugation;

e) Process according to the present invention: crushing, microwave dielectric heating of paste for 30 seconds at 800 W, malaxation for 30 minutes at 30° C. and extraction by centrifugation.

TABLE 2
Process conditions

| | | MW | MW | MW Olive | MW Olive |
|---|---|---|---|---|---|
| | tradizional | Olives 300 W | Olives 800 W | paste 300 W | paste 800 W |
| Free acidity (%) | 0.46 ± 0.2 | 0.48 ± 0.2 | 0.52 ± 0.3 | 0.51 ± 0.2 | 0.47 ± 0.3 |
| Number of peroxides | 5.53 ± 0.29 | 5.40 ± 0.40 | 5.65 ± 0.28 | 5.82 ± 0.36 | 5.50 ± 0.25 |
| K232 | 1.49 ± 0.02 | 1.49 ± 0.02 | 1.49 ± 0.03 | 1.48 ± 0.03 | 1.49 ± 0.02 |
| K270 | 0.11 ± 0.01 | 0.11 ± 0.01 | 0.11 ± 0.01 | 0.11 ± 0.01 | 0.11 ± 0.01 |
| Total phenols | 334.20 ± 21 | 401.62 ± 27 | 323.19 ± 33 | 381.33 ± 29 | 303.43 ± 18 |

Table 2 shows the main analytical parameters useful to define the produced oil quality by using the microwave dielectric heating in the process for extracting oil from olives. The analytical results show that all examined samples fall in the “extra virgin” category. The microwave dielectric heating of unbroken and crushed fruits at the tested temperature does not cause alterations in the oil so as to cause a decay of the commercial class.

In order to complete the framework of the product evaluation, the extracted oils were subjected to a tasting panel constituted by five tasters chosen among the technical personnel and the researchers trained for the product evaluation. All examined samples showed a pleasant fruity taste and had no defects.

Effect of the Microwave Dielectric Heating of Unbroken and Crushed Fruits on the Extraction Yields

To the purpose of evaluating the effect of the microwave dielectric heating of the unbroken and crushed fruits on the extraction yields the following tests were performed:
crushing, preheating up to 30° C., malaxation for 30 minutes at 30° C. centrifugation (branch C of the diagram in FIG. 7);
crushing followed directly by centrifugation (branch G of the diagram in FIG. 7);
crushing, microwave dielectric heating of the paste at 300 W (50 seconds/30° C.) followed directly by centrifugation (branch F of the diagram in FIG. 7);
crushing, microwave dielectric heating of the paste at 800 W (30 seconds/30° C.) seconds followed directly by centrifugation (branch F of the diagram in FIG. 7).

FIG. 11 represents the quantity of oil (g) extracted with laboratory centrifuge under different experimental conditions:
crushing, preheating up to 30° C., malaxation for 30 minutes at 30° C. and centrifugation (branch C of the diagram in FIG. 7 and histogram C of FIG. 11);
crushing followed directly by centrifugation (branch G of the diagram in FIG. 7 and histogram G of FIG. 11) crushing, microwave dielectric heating of paste at 300 W up to the temperature of 30° C. followed directly by centrifugation (branch F of the diagram in FIG. 7 and histogram D of FIG. 11);
crushing, microwave dielectric heating of paste at 800 W up to the temperature of 30° C. followed directly by centrifugation (branch F of the diagram in FIG. 7 and histogram E of FIG. 11).

By comparing the samples not subjected to microwave dielectric heating one can observe that the malaxated sample (branch C of the diagram in FIG. 7 and histogram C of FIG. 11) releases higher oil quantities with respect to the not malaxated sample (branch G of the diagram in FIG. 7 and histogram G of FIG. 11) as the mixing prolonged for long periods of time favours the coalescence of the very tiny oil drops released by the cells during crushing. The coalescence is necessary so that the oil drops reach a diameter suitable to favour the separation thereof by centrifugation.

By observing the values of the samples treated with microwave dielectric heating at 800 W one notes that, even in absence of malaxation, therefore of the prolonged period of time under stirring at controlled temperature, considerable oil quantities (branch F of the diagram in FIG. 7 and histogram E of FIG. 11) separate. Such phenomenon can be ascribed to the so-called non-thermal effects of microwaves.

By comparing the sample malaxated in traditional way (branch C of the diagram in FIG. 7 and histogram C of FIG. 11) with the samples malaxated by using the system of dielectric heating on unbroken or crushed fruits (branches E and F of the diagram in FIG. 7 and histograms E and F of FIG. 11) one observes that the microwave treated samples release higher oil quantities than the traditionally malaxated sample.

The present invention has been sofar described by referring to preferred embodiments thereof. It is to be meant that each one of the technical solutions implemented in the preferred embodiments herein described by way of example, could advantageously be combined differently therebetween, to implement other embodiments, belonging to the same inventive core and all however comprised within the protective scope of the herebelow reported claims.

1-25. (canceled)

26. A method for extracting oil from olives or oil-fruits, comprising the following steps:
performing a phase of crushing said olives, in order to obtain an olive paste;
performing a phase of malaxating said olive paste, to favour coalescence of oil drops; and
performing a thermal treatment of the olives or the olive paste in order to favour the coalescence, characterized in that said thermal treatment is performed by microwave dielectric heating;
wherein said thermal treatment comprises heating at a temperature comprised between 30° C. and 250° C. and said crushing phase and/or said malaxation phase are performed in a vacuum-sealed atmosphere or in a modified or controlled atmosphere.

27. The method according to claim 26, wherein the olives or the olive paste are heated at a temperature comprised between 30° C. and 40° C.

28. The method according to claim 26, wherein said thermal treatment is performed on the olives, before crushing.

29. The method according to claim 26, wherein said thermal treatment is performed on the olive paste, after crushing.

30. The method according to claim 26, wherein said malaxation phase is performed at a controlled malaxation temperature, between 30° C. and 40° C.

31. The method according to claim 30, wherein said malaxation temperature is 30° C.

32. The method according to claim 26, wherein said vacuum-sealed atmosphere of the crushing phase and/or malaxation phase is obtained by sucking air from a crushing and/or malaxation environment.

33. The method according to claim 26, wherein said modified or controlled atmosphere of the crushing phase and/or malaxation phase is obtained by inletting a gas or a gas mixture in a crushing and/or malaxation environment.

34. The method according to claim 33, wherein said gas is chosen among: nitrogen, argon, carbon dioxide, helium, or a mixture of the same or other gases, brought at a higher pressure than atmospheric pressure in the crushing and/or malaxation environment.

35. An apparatus for extracting oil from olives or oil-fruits, comprising:
a crusher to obtain olive paste;
a malaxator to malaxate said olive paste; and
a section for the thermal treatment of olives or olive paste;
\wherein said thermal treatment section comprises microwave dielectric heating means adapted to perform thermal treatment at a heating temperature comprised between 30° C. and 250° C., and said crusher and/or said malaxator are adapted to operate in a vacuum-sealed atmosphere or in a modified or controlled atmosphere.

36. The apparatus according to claim 35, wherein said heating temperature is comprised between 30° C. and 40° C.

37. The apparatus according to claim 35, wherein said thermal treatment section is placed upstream of the crusher.

38. The apparatus according to claim 35, wherein said thermal treatment section is placed downstream of the crusher.

39. The apparatus according to claim 35, wherein said malaxator comprises heating means adapted to control the temperature of malaxation between 30° C. and 250° C.

40. The apparatus according to claim 35, wherein said heating means keeps the temperature of malaxation between 30° C. and 40° C.

41. The apparatus according to claim 35, comprising means for sucking air from a crushing and/or malaxation environment.

42. The apparatus according to claim 35, comprising means for controlling or modifying the atmosphere of said crusher and/or said malaxator, in order to process in a modified or controlled atmosphere.

43. The apparatus according to claim 42, wherein said means for controlling or modifying the atmosphere comprises means for inletting a gas in the crushing and/or malaxation environment; said gas is chosen among: nitrogen, argon, carbon dioxide, or helium; and said means for controlling or modifying the atmosphere is adapted to bring said gas to a higher pressure than atmospheric pressure in the crushing and/or malaxation environment.
